(19) United States
(12) Patent Application Publication
(10) Pub. No.: US 2019/0101508 A1
(43) Pub. Date: Apr. 4, 2019

(54) SEPARATION MEDIUM FOR ELETROPHORESIS, REAGENT KIT FOR ELETROPHORESIS, AND ELETROPHORESIS METHOD

(71) Applicant: SHIMADZU CORPORATION, Kyoto (JP)

(72) Inventor: Akihiro ARAI, KYOTO (JP)

(73) Assignee: SHIMADZU CORPORATION, Kyoto (JP)

(21) Appl. No.: 16/149,140

(22) Filed: Oct. 2, 2018

(30) Foreign Application Priority Data
Oct. 2, 2017 (JP) 2017-192887

(51) Int. Cl. G01N 27/447

(52) U.S. Cl. CPC G01N 27/44747

(57) ABSTRACT

Provided is a separation medium for electrophoresis having an improved separation performance without increasing a viscosity. The separation medium for electrophoresis includes a water-soluble cellulose derivative, and a sugar alcohol derived from monosaccharide or disaccharide or a low-molecular-weight polysaccharide.

### CROSS-REFERENCE TO RELATED APPLICATION

This application claims the priority benefit of Japan Application No. 2017-192887, filed on Oct. 2, 2017. The entirety of the above-mentioned patent application is hereby incorporated by reference herein and made a part of this specification.

### BACKGROUND

### Technical Field

The disclosure relates to a separation medium for electrophoresis, a reagent kit for electrophoresis, and an electrophoresis method.

### Related Art

In a method of conducting an electrophoresis in a capillary, such as a microchip electrophoresis method, a capillary electrophoresis method and the like, it is common that a water-soluble polymer solution is used as a separation medium for nucleic acid (for example, DNA, RNA), protein and the like. The water-soluble polymer solution is selected so as to meet the requirements of a filling in a flow path, an easy substitution, a separation performance and a rapid separation. For example, when a short-chain DNA is electrophoresed, a water-soluble polymer solution having a relatively low molecular weight and a high concentration is used. Besides, examples are reported that for purpose of expanding a size range of separation and promoting an adsorption to the surface of the flow path, a copolymer such as a random copolymer (for example, poly(acrylamide-co-dimethyl acrylamide)), a block copolymer (for example, poly(ethylene oxide)-polypropylene oxide)) and a graft polymer (for example, poly(N-isopropyl acrylamide)-graft-polyethylene oxide), or a mixed polymer obtained by mixing heterogeneous or homogeneous polymers is used (Japanese Laid-open No. 2014-055829 (patent literature 1) and so on).

[Patent literature 1] Japanese Laid-open No. 2014-055829

Meanwhile, in recent years, a genome editing technology for changing any base sequence has proceeded rapidly. Presence or absence of a mutation in the target base sequence is confirmed in the genome editing technology, but the means takes time and costs to confirm an insertion mutation or a deletion mutation of a few bases by a DNA sequencing every time, and thus the means should be improved. As an alternative technology of such DNA sequencing, a microchip electrophoresis method that can simply and inexpensively conduct a screening is used. For example, the screening method using the microchip electrophoresis method is conducted as follows. Firstly, a genome DNA containing a target base sequence is used as a template, and a DNA product containing the target base sequence is amplified by a polymerase chain reaction (PCR). Here, when the genome DNA in which a wild-type sequence and a mutant-type sequence are mixed in the target base sequence is used as a template, a double-stranded DNA product (a heteroduplex DNA) containing a partial mismatch is obtained by PCR. The heteroduplex DNA is different in mobility in the electrophoresis compared with the double-stranded DNA product (a homoduplex DNA) of the sequences which maintain a complementation. Therefore, the DNA product containing the target base sequence can be screened using the mobility in the electrophoresis as an index.

However, even if the screening method using the microchip electrophoresis method is used, it is limited to detect differences of 2-8 bp in 100 bp of the double-stranded DNA product obtained by PCR, and a separation performance in a short-chain area (for example, 25-250 bp) should be further improved. In order to improve the separation performance of the double-stranded DNA product in the short-chain area, a method is conventionally known which uses a relatively low-molecular-weight water-soluble polymer as a separation medium at a high concentration. However, there is a problem in this method that the viscosity of the separation medium increases, so that a device is separately required to apply a sufficient pressure to the flow path in the refilling and substitution of the separation medium when the microchip is used repeatedly, and the electrophoresis device becomes large.

### SUMMARY

The present application provides the following disclosure.

An embodiment of the disclosure provides a separation medium for electrophoresis including: a water-soluble cellulose derivative; and

a sugar alcohol derived from monosaccharide or disaccharide, or a low-molecular-weight polysaccharide.

According to an embodiment of the disclosure, in the separation medium for electrophoresis, the sugar alcohol includes mannitol, erythritol, xylitol, lactitol, maltitol, sorbitol, or a combination thereof.

According to an embodiment of the disclosure, in the separation medium for electrophoresis, a weight-average molecular weight of the polysaccharide is 10000-80000.

According to an embodiment of the disclosure, in the separation medium for electrophoresis, the polysaccharide includes: pullulan, agarose, dextran, dextrin, amylose, xanthan gum, mannan, galactomannan, gellan gum, carrageenan, curdlan, pectine, welan gum, alginic acid, alginic acid salt, alginic acid ester, karaya gum, tamarind seed gum, rhamsan gum, or a combination thereof.

According to an embodiment of the disclosure, in the separation medium for electrophoresis, the sugar alcohol or the polysaccharide includes mannitol, pullulan, or a combination thereof.

According to an embodiment of the disclosure, in the separation medium for electrophoresis, the water-soluble cellulose derivative contains repeating units of cellulose, in which at least one hydrogen atom of a hydroxyl group is substituted by a substituent which is selected from a group consisting of an alkyl group having 1 to 3 carbon atoms, a hydroxyalkyl group having 1 to 3 carbon atoms, a carboxymethyl group having 2 to 4 carbon atoms, a group denoted by —(CH₂O)ₓ—H, a group denoted by —(CH₂CH₂O)_{y}—H, and a group denoted by —[CH₂CH(CH₃)O]_{z}—H (x, y, z respectively and independently represent a positive integer).

According to an embodiment of the disclosure, in the separation medium for electrophoresis, the water-soluble cellulose derivative includes one or more than two selected from a group consisting of methyl cellulose, hydroxymethyl cellulose, hydroxyethyl cellulose, hydroxypropyl cellulose, and carboxymethyl cellulose.

An embodiment of the disclosure provides a reagent kit for electrophoresis including the above separation medium for electrophoresis.

An embodiment of the disclosure provides an electrophoresis method which is an electrophoresis method of an object substance in a sample, including:

(A) a process for introducing the sample to a flow path filled with the above separation medium for electrophoresis; and
(B) a process for applying a voltage to the flow path to conduct an electrophoresis and separate the object substance in the sample.

According to an embodiment of the disclosure, in the electrophoresis method, the object substance includes nucleic acid (for example, DNA, RNA) or protein.

### BRIEF DESCRIPTION OF THE DRAWINGS

FIG. 1 is an electropherogram which compares the separation performances of a separation medium for electrophoresis in the present embodiment and a conventional separation medium for electrophoresis. The number notated at the vertex of a peak is the number of each peak assigned according to a detection order, and the same number represents the same DNA fragment.

FIG. 2 is a graph showing a correlation between a size (bp) of a DNA product and a size resolution (%).

FIG. 3 is a graph showing a correlation between the size (bp) of the DNA product and a separable size difference (bp).

FIG. 4 is an electropherogram which compares the separation performances of a separation medium for electrophoresis in which mannitol is added to a water-soluble cellulose derivative, and a separation medium for electrophoresis in which mannitol is not added to a water-soluble cellulose derivative. The number notated at the vertex of a peak is the number of each peak assigned according to the detection order, and the same number represents the same DNA fragment.

FIG. 5 is an electropherogram which compares the separation performances of the separation medium for electrophoresis in which mannitol is added to the water-soluble cellulose derivative, and the separation medium for electrophoresis in which mannitol is not added the water-soluble cellulose derivative. The number notated at the vertex of a peak represents the size (bp) of a DNA fragment corresponding to each peak. Besides, notations of (L M) and (U M) respectively represent a low-molecular-weight internal standard marker and a high-molecular-weight internal standard marker.

FIG. 6 is an electropherogram which compares the separation performances of a separation medium for electrophoresis in which pullulan is added to a water-soluble cellulose derivative, and a separation medium for electrophoresis in which pullulan is not added to a water-soluble cellulose derivative. The number notated at the vertex of a peak represents the size (bp) of the DNA fragment corresponding to each peak. Besides, notations of (LM) and (UM) respectively represent the low-molecular-weight internal standard marker and the high-molecular-weight internal standard marker.

FIG. 7 is an electropherogram which compares the separation performances of the separation medium for electrophoresis in which mannitol is added to the water-soluble cellulose derivative, and the separation medium for electrophoresis in which mannitol is not added to the water-soluble cellulose derivative. The number notated at the vertex of the peak represents the size (bp) of the DNA fragment corresponding to each peak. Besides, notations of (LM) and (UM) respectively represent the low-molecular-weight internal standard marker and the high-molecular-weight internal standard marker.

FIG. 8 is an electropherogram showing the separation performance in a case of using a separation medium for electrophoresis containing HPMC with a large weight-average molecular weight. The number notated at the vertex of the peak represents the size (bp) of the DNA fragment corresponding to each peak. Besides, the notation of (LM) represents the low-molecular-weight internal standard marker.

### DESCRIPTION OF THE EMBODIMENTS

The disclosure provides a separation medium for electrophoresis having an improved separation performance without increasing a viscosity.

After conducting an intensive study, the present inventor finds that by adding a sugar alcohol derived from monosaccharide or disaccharide or a low-molecular-weight polysaccharide to a separation medium for electrophoresis including a water-soluble cellulose derivative, the separation performance in an electrophoresis is improved without increasing viscosity, and thus accomplishes the disclosure. An embodiment of the disclosure is described below, but the disclosure is not limited thereto. Besides, a notation of “A-B” refers to an upper and lower limit of a range (that is, more than A and less than B); when a unit is only mentioned in B without being mentioned in A, the units of A and B are the same.

(Separation Medium for Electrophoresis)

A separation medium for electrophoresis of the present embodiment (it may be only referred to as the “separation medium for electrophoresis” hereinafter) includes a water-soluble cellulose derivative, and a sugar alcohol derived from monosaccharide or disaccharide or a low-molecular-weight polysaccharide. By having such a structure, the separation medium for electrophoresis can improve the separation performance without increasing the viscosity. Here, the “separation performance” refers to a performance that can separate and detect object substances corresponding to two adjacent peaks, to a degree that the two adjacent peaks can be respectively identified as separate peaks, in an electropherogram obtained by an electrophoresis. The separation performance of the separation medium for electrophoresis can be assessed according to a size resolution, a degree of separation, a separable size difference and the like described below.

The “separation medium for electrophoresis” refers to a medium which is capable of introducing a sample, and which electrophoreses and separates the sample.

The “water-soluble cellulose derivative” refers to a cellulose derivative which converts at least one hydroxyl group (—OH) in a repeating unit of cellulose to an ether (—OR) and improves a water solubility. Here, the “water solubility” refers to a solubility of more than 1 g in 100 g of distilled water in 25° C., 1 air pressure.

Preferably, the water-soluble cellulose derivative includes repeating units of cellulose, in which at least one hydrogen atom of a hydroxyl group is substituted by a substituent which is selected from the group consisting of an alkyl group having 1 to 3 carbon atoms, a hydroxyalkyl group having 1 to 3 carbon atoms, a carboxymethyl group having 2 to 4 carbon atoms, a group denoted by —(CH₂O)ₓ—H, a group denoted by —(CH₂CH₂O)_{y}—H, and a group denoted by —[CH₂CH(CH₃)O]_{z}—H (x, y, z respectively and independently represent a positive integer). More preferably, the substituent includes the alkyl group having 1 to 3 carbon atoms or the hydroxyalkyl group having 1 to 3 carbon atoms.

That is, the water-soluble cellulose derivative is denoted by the following formula (I).

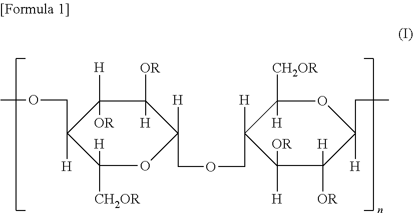

In the formula, preferably, each R is independently selected from the group consisting of the hydrogen atom, the alkyl group having 1 to 3 carbon atoms, the hydroxyalkyl group having 1 to 3 carbon atoms, the carboxymethyl group having 2 to 4 carbon atoms, the group denoted by —(CH₂O)ₓ—H, the group denoted by —(CH₂CH₂O)_{y}—H, and the group denoted by —[CH₂CH(CH₃)O]_{z}—H (x, y, z respectively and independently represent a positive integer). More preferably, each R is independently selected from the group consisting of the hydrogen atom, the alkyl group having 1 to 3 carbon atoms, and the hydroxyalkyl group having 1 to 3 carbon atoms. n represents a positive integer.

The water-soluble cellulose derivative includes, for example, an alkyl cellulose such as methyl cellulose, ethyl cellulose and propyl cellulose; a hydroxyalkyl cellulose such as hydroxymethyl cellulose, hydroxyethyl cellulose (HEC) and hydroxypropyl cellulose; a hydroxyalkylalkyl cellulose such as hydroxyethylmethyl cellulose, hydroxyethylethyl cellulose and hydroxypropylmethyl cellulose (HPMC); and a carboxyalkyl cellulose such as carboxymethyl cellulose, carboxyethyl cellulose and carboxypropyl cellulose (the form of a salt such as an alkaline metal salt is also included), and carboxyalkyl hydroxyalkyl cellulose such as carboxymethyl hydroxyethyl cellulose (the form of a salt such as an alkaline metal salt is also included); one of these may be selected to be used or multiple of these may be combined to be used. Preferably, the water-soluble cellulose derivative includes one or more than two selected from the group consisting of hydroxypropylmethyl cellulose, methyl cellulose, hydroxymethyl cellulose, hydroxyethyl cellulose, hydroxypropyl cellulose, and carboxymethyl cellulose. More preferably, the water-soluble cellulose derivative contains hydroxypropylmethyl cellulose.

The weight-average molecular weight (M_{w}) of the water-soluble cellulose derivative is preferably 50000-2000000, more preferably 250000-1300000, and further preferably 300000-370000. When the weight-average molecular weight is in this range, the conditions may be easily found which can further meet the separation performance without increasing the viscosity of the separation medium for electrophoresis as much as possible, together with the optimization of the concentration. The weight-average molecular weight can be measured by a light scattering method or a gel permeation chromatography (GPC).

A number-average molecular weight (Mₙ) of the water-soluble cellulose derivative is preferably 20000-500000, and more preferably 80000-160000. The number-average molecular weight can be measured by the light scattering method or the gel permeation chromatography (GPC).

A polydispersity (M_{w}/Mₙ) of the water-soluble cellulose derivative may be 1.0-100.0, 2.0-20.0, or 3.0-4.0. The polydispersity can be calculated by dividing the weight-average molecular weight with the number-average molecular weight.

The viscosity of the water-soluble cellulose derivative (concentration of 2 wt %, temperature of 25° C.) is preferably 50-4000 cP, and more preferably 50-100 cP. When the viscosity is in this range, the filling and the substitution of the separation medium for electrophoresis in the flow path of the electrophoresis become easier. The viscosity can be measured by Brookfield viscometer.

The concentration of the water-soluble cellulose derivative in the separation medium for electrophoresis may be 0.2-2.0% (w/v) or 0.5-1.6% (w/v).

The water-soluble cellulose derivative may be produced by a known method. Besides, the water-soluble cellulose derivative may be a commercial product directly used without refinement, or a commercial product used after refinement. When HPMC is used as the water-soluble cellulose derivative, the commercial products include, for example, HPMC made by Sigma-Aldrich Co. LLC, which is used in a practical example described below.

The “sugar alcohol” refers to a chain polyhydric alcohol in which a carbonyl group of the sugar is reduced. The “sugar alcohol derived from monosaccharide or disaccharide” refers to a sugar alcohol obtained by reducing monosaccharide or disaccharide. In the embodiment, the sugar alcohol includes, for example, mannitol, erythritol, xylitol, lactitol, maltitol and sorbitol, and one of these may be selected to be used or multiple of these may be combined to be used. Furthermore, when optical isomers (D-isomer and L-isomer) exist in the sugar alcohol, any one of the optical isomers may be used or a mixture of the two may be used. Preferably, the sugar alcohol includes mannitol.

The concentration of the sugar alcohol in the separation medium for electrophoresis is preferably 1-5 wt % and more preferably 1-3 wt %. When the concentration is in this range, the separation performance of the separation medium for electrophoresis can be further improved.

The “polysaccharide” refers to a high molecular compound obtained by the polyglycosylation of monosaccharide. In the embodiment, the “low-molecular-weight polysaccharide” refers to a polysaccharide with a low molecular weight so that the polysaccharide itself does not function as a separation medium for DNA and other object substances, and may be, for example, a polysaccharide with a weight-average molecular weight described below. The polysaccharide includes, for example, pullulan, agarose, dextran, dextrin, amylose, xanthan gum, mannan, galactomannan, gellan gum, carrageenan, curdlan, pectine, welan gum, alginic acid, alginic acid salt (for example, sodium alginate, potassium alginate, calcium alginate, ammonium alginate and the like), alginic acid ester (for example, propylene glycol alginate and the like), karaya gum, tamarind seed gum, rhamsan gum and the like; one of these may be selected to be used, or multiple of these may be combined to be used. Preferably, the polysaccharide includes pullulan.

The weight-average molecular weight (M_{w}) of the polysaccharide is preferably 10000-80000, more preferably 20000-80000, and further preferably 22800-80000. By appropriately using the polysaccharide with a weight-average molecular weight in the above range, a thickening effect can be reduced as much as possible. The weight-average molecular weight can be measured by the gel permeation chromatography (GPC).

The concentration of the polysaccharide in the separation medium for electrophoresis is preferably 0.2-5 wt %, and more preferably 0.25-1.0 wt %. When the concentration of the polysaccharide is in this range, the separation performance of the separation medium for electrophoresis can be further improved.

Preferably, the sugar alcohol or the polysaccharide contains mannitol, pullulan, or a combination thereof.

The separation medium for electrophoresis is usually a liquid, preferably an aqueous solution, and more preferably an aqueous solution having a buffer capacity (also referred to as a “buffer solution” hereinafter). Here, the “buffer capacity” refers to a buffer action on the concentration of hydrogen ions in the solution. The buffer solution includes TBE buffer solution (89 mM of Tris, 89 mM of boric acid, 2 mM of EDTA-Na₂, pH8.3), TAE buffer solution (40 mM of tris hydroxymethyl aminomethane (Tris), acetic acid, 1 mM of ethylenediaminetetraacetic acid disodium salt (EDTA-Na₂), pH8.3) and the like. Besides, there is an occasion that the ionic strength of these buffer solutions is changed to be used. For example, 2×TBE buffer solution (178 mM of tris hydroxymethyl aminomethane (Tris), 178 mM of boric acid, 4 mM of ethylenediaminetetraacetic acid disodium salt (EDTA-Na₂), pH8.3) and the like are used.

The viscosity of the separation medium for electrophoresis (temperature of 25° C.) is preferably 10-200 cP, and more preferably 20-100 cP. When the viscosity is in this range, the filling and the substitution of the separation medium for electrophoresis in the flow path of the electrophoresis become easier. The viscosity can be measured by Brookfield viscometer.

The separation medium for electrophoresis may include, in the scope of not impairing an effect of the embodiment, a DNA staining reagent (for example, product of Thermo Fisher Scientific Inc., brand name: SYBR (registered trademark) Gold), product of Lonza Rockland, Inc., brand name: GelStar (registered trademark) and other components.

In a case of using a nucleic acid (for example, DNA or RNA) as the electrophoretic object substance, in the separation medium for electrophoresis of the embodiment, the size resolution (%) in the size area of 100-300 bp is preferably less than 3%. Here, the size resolution (%) refers to a ratio of a separable minimum size difference (bp) with respect to the size (bp) of the electrophoretic DNA fragment. A smaller size resolution means that two DNA fragments with a small size difference can be distinguished more accurately and the separation performance is excellent. The separation medium for electrophoresis with such a size resolution is suitable for the electrophoresis which confirms a mutation introduction caused by a genome editing. The size resolution can be calculated from the electropherogram obtained by the electrophoresis. Specifically, the size resolution focuses on two close peaks (referred to as “a first peak” and “a second peak”) in the electropherogram, and can be obtained from the following formula. Here, the size of the first peak (bp) is set smaller than the size of the second peak (bp).

Size resolution (%)=(size separation performance [bp]/size of the first peak [bp])

(wherein, size separation performance [bp]=(size difference [bp] of two close peaks)/Rₛ)

Here, Rₛ refers to a degree of separation when assuming that the widths and heights of the two close peaks are about the same. When Rₛ is larger than a specified reference value, it is judged that the two close peaks are separated. For example, in a case of Rₛ≥0.8, it may be judged that the two close peaks are sufficiently separated. Rₛ is calculated by the following formula.

$${R}_{s} = 2 \times \frac{{t}_{2} - {t}_{1}}{{w}_{b , 1} + {w}_{b , 2}} or \\ {R}_{s} = \frac{{t}_{2} - {t}_{1}}{4 σ} = \frac{{t}_{2} - {t}_{1}}{4 \times \frac{{W}_{h}}{\sqrt{8 ln 2}}} = 0.589 \frac{{t}_{2} - {t}_{1}}{{W}_{h}} \qquad [ Formula 1 ]$$

In the formula, t refers to an electrophoresis time, w_{b} refers to a peak width in a base line, 4σ refers to a peak width in a base line when the peak is in a Gaussian distribution, and Wₕ refers to a peak width in the ½ peak height. Inferior figures in t and w_{b} refer to the numbers of the corresponding peaks. However, 4σ is used in a state that the expansion of the peak in the electrophoresis flow path can be assumed to be denoted by a formula of dispersion σ²=2Dt (D is a diffusion coefficient) and the peak expansion due to factors other than a diffusion (for example, an adsorption of the sample component to an inner wall of the flow path) can be ignored. For example, t₁ refers to an electrophoresis time of the first peak, and t₂ refers to an electrophoresis time of the second peak.

In a case of using DNA or RNA as the electrophoretic object substance, in the separation medium for electrophoresis of the embodiment, the separable size difference in the size area of 25-100 bp is preferably 1-5 bp, and more preferably 1-3 bp. The separation medium for electrophoresis with such a separable size difference is suitable for the electrophoresis which confirms the mutation introduction caused by the genome editing. The separable size difference refers to a difference of the fragment size (the length of the chain) in two peaks, which is necessary for Rₛ=0.8. A smaller separable size difference means that two DNA fragments having a small size difference can be separated more accurately and the separation performance is excellent. The separable size difference can be calculated from the electropherogram obtained by the electrophoresis.

The separation medium for electrophoresis of the embodiment includes the water-soluble cellulose derivative, and the sugar alcohol or the relatively low-molecular-weight polysaccharide. By having such a structure, the separation medium for electrophoresis can improve the separation performance without increasing the viscosity significantly. A method is conventionally known which uses a relatively low-molecular-weight water-soluble polymer as a separation medium at a high concentration in order to improve the separation performance of a double-stranded DNA product in a short-chain area (for example, 25-250 bp). However, there is a problem in this method that the viscosity of the separation medium increases, so that a device is separately required to apply a sufficient pressure in the refilling and substitution of the separation medium when the microchip is used repeatedly, and the electrophoresis device becomes large. The separation medium for electrophoresis adds a low-molecular-weight sugar alcohol or a polysaccharide (for example, the molecular weight is about or less than 80000), which does not function by itself as a separation medium for DNA and other object substances, to the water-soluble cellulose derivative which is a water-soluble polymer, and thus the separation performance can be improved without increasing the viscosity significantly.

Furthermore, the water-soluble cellulose derivative (for example, HPMC) contains a plurality of hydroxyl groups, hydroxypropyl groups and the like of the cellulose, and can form a hydrogen bond with the sugar alcohol or the polysaccharide. Therefore, instead of crosslinking on a molecular structure in a single component, the cellulose derivative molecules on a straight chain interact with each other due to the intervention of the sugar alcohol or the polysaccharide, and a network structure which impacts a sieving effect is changed. Furthermore, the hydroxyl groups, the hydroxypropyl groups and the like of the cellulose can also form hydrogen bonds with DNA. Therefore, the electrophoretic DNA product in the separation medium for electrophoresis of the embodiment is impacted by the pure separation caused by size and an affinity caused by the hydrogen bond, so that a separation selectivity is changed. As a result, it is considered by the inventors that due to the difference of the base sequences and the presence or absence of slight mutation even if the DNA size is the same in the short chain area, a difference is generated on the mobility in the electrophoresis. When such a mechanism is considered, the sugar alcohol and the polysaccharide used in the embodiment have the same technical characteristic of being capable of forming a hydrogen bond to the water-soluble cellulose derivative. Furthermore, it is not limited to the sugar alcohol and the polysaccharide; as long as a compound that can form a hydrogen bond, the compound can be used as the separation medium for electrophoresis by combining the compound with the water-soluble cellulose derivative. The compound that can form a hydrogen bond includes, for example, a compound containing a COOH group or a NH₂ group and the like.

(Reagent Kit for Electrophoresis)

The reagent kit for electrophoresis of the embodiment (also referred to as “the reagent kit” hereinafter) includes the separation medium for electrophoresis. The reagent kit may include the buffer solution, the DNA staining reagent, the molecular weight marker, the internal standard marker, a container, an instruction manual and the like.

(Electrophoresis Method)

The electrophoresis method of the embodiment is an electrophoresis method of the object substance in the sample and includes:

(A) a process for introducing the sample to a flow path filled with a separation medium for electrophoresis, and
(B) a process for applying a voltage to the flow path to conduct an electrophoresis and separate the object substance in the sample.

Process (A): a process for introducing the sample to the flow path filled with the separation medium for electrophoresis

The “flow path filled with a separation medium for electrophoresis” in process (A) refers to a flow path which allows the object substance in the sample to move by the electrophoresis, and which is filled with the separation medium for electrophoresis of the embodiment. The length of the flow path is not particularly limited and may be, for example, 10-40 mm. The size of the flow path (for example, the internal diameter of a capillary tube which is a flow path, the width of a flow path arranged on the microchip, and the like) is not particularly limited and may be, for example, 20-100 μm.

The flow path may be the capillary tube or the micro flow path arranged on the microchip. When the capillary tube or the micro flow path arranged on the microchip is configured by glass, the surface of the flow path may be coated (for example, polyacrylamide coating) in order to suppress an electroosmotic flow, or to inhibit the adsorption of contaminants in the sample. The polyacrylamide coating is performed on the surface of the flow path in the following way for example. Firstly, a silane coupling agent containing a methacrylic group is made to act on the surface of the micro flow path and the methacrylic group is introduced to the surface. Next, an acrylamide monomer is made to act on the methacrylic group and a polymerization reaction is promoted in a predetermined condition, so that the polyacrylamide coating is conducted on the surface of the micro flow path.

The sample introduced to the flow path is not particularly limited, but is preferably a solution; for example, the sample may be a TE buffer solution (10 mM of Tris-HCl, 1 mM of EDTA-Na₂, pH8.0) in which DNA is dissolved. The sample may include the internal standard marker. The internal standard marker includes, for example, an internal standard marker in DNA-500 reagent kit for brand name MCE (registered trademark)-202 MultiNA (registered trademark) made by Shimadzu Corporation.

The object substance in the sample is not particularly limited as long as the object substance is an ionized substance, but preferably includes nucleic acid (for example, DNA, RNA) or protein, and more preferably includes DNA. The DNA may be a double-stranded DNA (for example, a heteroduplex DNA, a homoduplex DNA and the like) or a single-stranded DNA.

The sample may be introduced to any position of the flow path, but from the standpoint of ensuring an adequate electrophoresis distance, the sample is preferably introduced to one end side of the flow path.

Process (B): a process for applying a voltage to the flow path to conduct an electrophoresis and separate the object substance in the sample

The voltage in process (B) may be applied to the whole or a part of the flow path. From the standpoint of ensuring adequate electrophoresis distance, the voltage is preferably applied between two ends of the flow path. The applied voltage can be appropriately determined according to the length and size of the electrophoresis flow path, and the type of the sample and object substance. The applied voltage is, for example, 0.2-10 kV.

The electrophoresis method may further include a process (C) for detecting the separated object substance. Process (C) may include a detection of the separated object substance by an optical technique. The detection using the optical technique is, for example, a measurement of absorbance or fluorescence. The wavelength used in the detection can be appropriately determined according to the type of the sample and object substance.

The electrophoresis method of the embodiment may be automatically conducted, for example, by a microchip electrophoresis device from process (A) to process (C). The microchip electrophoresis device may be, for example, MCE (registered trademark)-202 MultiNA (registered trademark) (brand name) made by Shimadzu Corporation. Specifically, firstly, the microchip (for example, brand name Type WE made by Shimadzu Corporation), the separation medium for electrophoresis, the sample, and the internal standard marker are set on the microchip electrophoresis device. After that, the pressure for filling the separation medium for electrophoresis (100-500 kPa) and the voltage applied to the two ends of the flow path arranged on the microchip (0.2-1.4 kV) are changed as necessary, and the electrophoresis is conducted automatically.

The electrophoresis method of the embodiment is suitable for an electrophoresis which confirms the mutation introduction caused by the genome editing, particularly for a separation of the heteroduplex DNA product.

### Practical Example

In the following, the disclosure is described in more detail by showing practical examples, but the disclosure is not limited by these practical examples.

(Preparation of Separation Medium for Electrophoresis)

### 1. Preparation of TBE Buffer Solution Containing HPMC

As for the hydroxypropylmethyl cellulose (HPMC), the commercial product (made by Sigma-Aldrich Co. LLC) is used directly without refinement. The number-average molecular weight (Mₙ), the weight-average molecular weight (M_{w}), and the polydispersity (M_{w}/Mₙ) of each HPMC are measured by the gel permeation chromatography (GPC). Specifically, a standard sample with a known molecular weight (a molecular weight of 504-1800000) is used to conduct a GPC analysis, and a calibration curve is created from an elution time. The sample (a concentration of 0.4% (w/v)) containing each HPMC which is a measured object is used to conduct the GPC analysis in the same analysis condition as the case of the standard sample, and Mₙ, M_{w} and M_{w}/Mₙ are calculated based on the calibration curve.

Analysis Condition of GPC

Column: Shodex OHpak SB-806M HQ, guard column Shodex OHpak SB-G
Mobile phase: 0.1 mol/L sodium nitrate
Flow rate: 1.0 mL/min

### Temperature: 40° C.

Detector: refractive index detector, made by Shimadzu Corporation, RID-20A (brand name)

The viscosity of each HPMC is measured by Brookfield viscometer. Specifically, the viscosity is measured in the following order. Firstly, a viscometer standard solution of NIST compliance (100 mPa·s) is used to verify a validity of the measurement method, and the viscosity of the sample (a concentration of 2.0% (w/v)) containing HPMC which is a measured object is measured in the same condition.

Viscosity measuring condition

### Viscometer: Brookfield DV-II+Pro

### Spindle: CPA-40Z

### Temperature: 25° C.

A list of the HPMC used is shown in Table 1.

TABLE 1

| | | Number- | Weight- | | |
|---|---|---|---|---|---|
| | | average | average | | Viscosity |
| | | molecular | molecular | Poly- | (cP) |
| | | weight | weight | dispersity | 2 wt %, |
| # | Brand name | (Mₙ) | (M_{w}) | (M_{w}/Mₙ) | 25° C. |
| 1 | Hydroxypropyl | 88070 | 314800 | 3.57 | 56.9 |
| | methylcellulose, | | | | |
| | 50 cP | | | | |
| 2 | Hydroxypropyl | 117180 | 365840 | 3.12 | 98.2 |
| | methylcellulose, | | | | |
| | 100 cP | | | | |
| 3 | Hydroxypropyl | 300290 | 1023060 | 3.41 | 4000* |
| | methylcellulose, | | | | |
| | 4000 cP | | | | |

*Viscosity measuring condition: Brookfield DV-II + Pro Viscometer, spindle: CPA-40Z

After that, each HPMC is completely dissolved in the 2×TBE buffer solution (178 mM of Tris, 178 mM of boric acid, 4 mM of EDTA-Na₂, pH8.3) so that the concentration reaches 2% (w/v), and a TBE buffer solution containing HPMC is obtained. The TBE buffer solution containing HPMC is kept not to exceed a lower critical solution temperature (45° C.) until it is used. Besides, when HPMC in the buffer solution does not dissolve due to a heat load, the HPMC is re-dissolved by cooling.

### 2. Preparation of Separation Medium for Electrophoresis

In the TBE buffer solution containing the prepared HPMC, SYBR (registered trademark) Gold (made by Thermo Fisher Scientific Inc., brand name) which is a DNA staining reagent is dissolved in the way of 1/10000 concentration (or ×10,000 fold dilution); furthermore, mannitol or pullulan is dissolved to the concentration described below and sufficiently mixed, thereby obtaining the separation medium for electrophoresis.

(Preparation of Sample for Electrophoresis)

A DNA size marker which is an object substance (25 bp DNA ladder made by Invitrogen Corporation, or 25 bp DNA step ladder made by Promega Corporation) is diluted to 7.2-20 ng/μL by a TE buffer solution (10 mM of Tris-HCl, 1 mM of EDTA-Na₂, pH8.0) to prepare the sample for electrophoresis. The internal standard marker is the internal standard marker used for DNA analysis (DNA-500 reagent kit for brand name MCE (registered trademark)-202 MultiNA (registered trademark) made by Shimadzu Corporation).

(Measurement Order of Data)

The microchip (product of Shimadzu Corporation, brand name Type WE), the separation medium for electrophoresis, the sample, and the internal standard marker are set on the microchip electrophoresis device (product of Shimadzu Corporation, brand name MCE (registered trademark)-202 MultiNA (registered trademark)). After that, the pressure for filling the separation medium for electrophoresis (100-500 kPa) and the voltage applied to the two ends of the flow path arranged on the microchip (0.2-1.4 kV) are changed as necessary to conduct the electrophoresis automatically, and the obtained experimental data is analyzed.

(Comparison Between Separation Medium for Electrophoresis of the Embodiment and a Conventional Separation Medium for Electrophoresis)

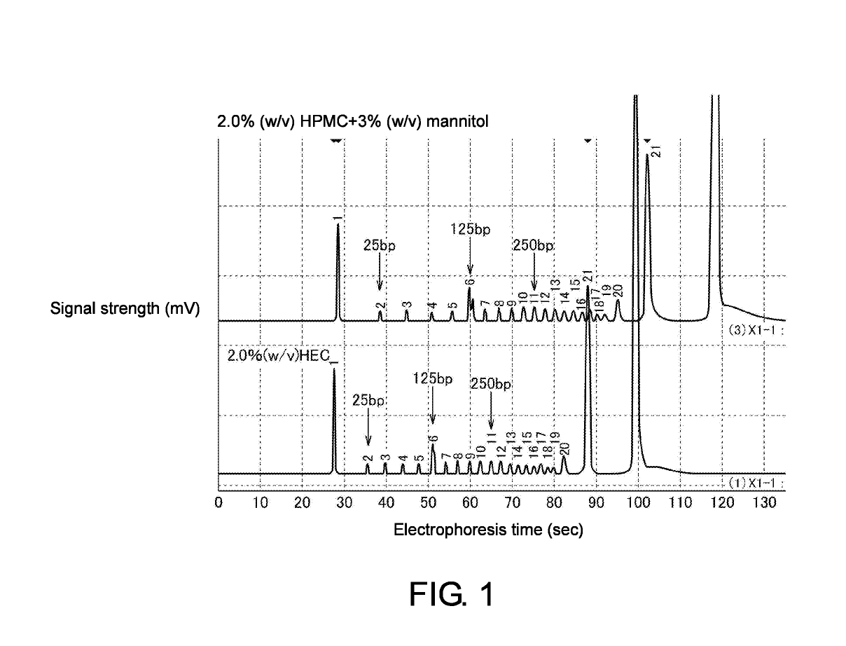

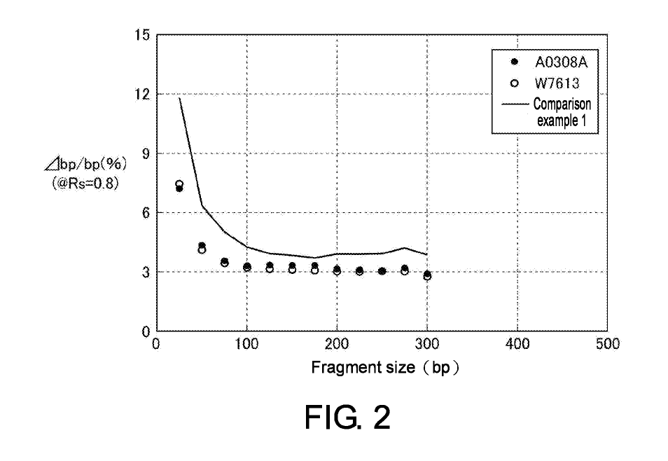

An experimental result is shown in FIG. 1 to FIG. 3 and Table 2, which is obtained by comparing the separation medium for electrophoresis of the embodiment (2.0% (w/v) HPMC (#2 in Table 1)+3% (w/v) mannitol; practical example 1), and the separation medium for electrophoresis which is conventionally used (2.0% (w/v) hydroxyethyl cellulose (HEC), (weight-average molecular weight M_{w}=475000, polydispersity Mw/Mn=4.28, Brookfield viscosity is 90 cP (2 wt %, 25° C.)); comparison example 1). In FIG. 2, 3 and Table 2, the notations of “A0308A”, “W7613” refer to chip ID, the measurement is conducted in the same separation condition except for using different chips, and both are included in practical example 1. The object substance is a DNA size marker (to 500 bp) made by Invitrogen Corporation, and the internal standard marker is a marker on a high molecular side included in the DNA-500 reagent kit for MCE (registered trademark)-202 MultiNA (registered trademark).

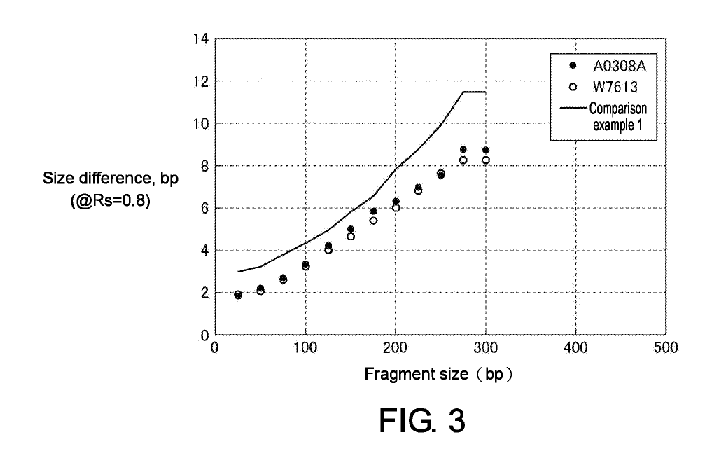

When the electropherogram (FIG. 1) is compared, the viscosity of the separation medium for electrophoresis is equal in degree, but the electrophoresis time in practical example 1 is later than that in comparison example 1, and the interval between the peaks near 300 bp is expanded and the separation performance is improved. Furthermore, the size resolution (%) in the size area of 100-300 bp is about 4% in comparison example 1, but in practical example 1, the size resolution is improved to about 3% (FIG. 2). Besides, the separable size difference in the size area of 25-100 bp is 3-4 bp in comparison example 1, but in practical example 1, the separable size difference is improved to less than 3 bp (FIG. 3).

TABLE 2

| | | | | Comparison |
|---|---|---|---|---|
| | | Practical example 1 | | example 1 |
| Separation medium for | | 2.0% (w/v) HPMC | | 2.0% (w/v) HEC |
| electrophoresis | | (#2) + 3% | | |
| | | (w/v) mannitol | | |
| Viscosity of | | 98 cP | | 100 cP |
| separation medium | | | | |
| for electrophoresis | | | | |
| Electrophoresis | Chip ID | A0308A | W7613 | A0308A |
| time (sec) | #2 (25 bp) | 38.48 | 38.32 | 35.56 |
| | #6 (125 bp) | 59.90 | 59.76 | 50.84 |
| | #11 (250 bp) | 75.28 | 75.28 | 64.98 |
| Degree of | 100 bp | 5.21 | 4.97 | 2.87 |
| separation Rₛ | | | | |
| Size resolution | 100-300 bp | About 3% | About 3% | About 4% |
| (%) Δbp/bp | | | | |
| Separable size | 25-100 bp | Less than | Less than | 3-4 bp |
| difference | | 3 bp | 3 bp | |
| Δbp | | | | |

(Verification of Improvement Effect in Separation Performance by Adding Mannitol into HPMC)

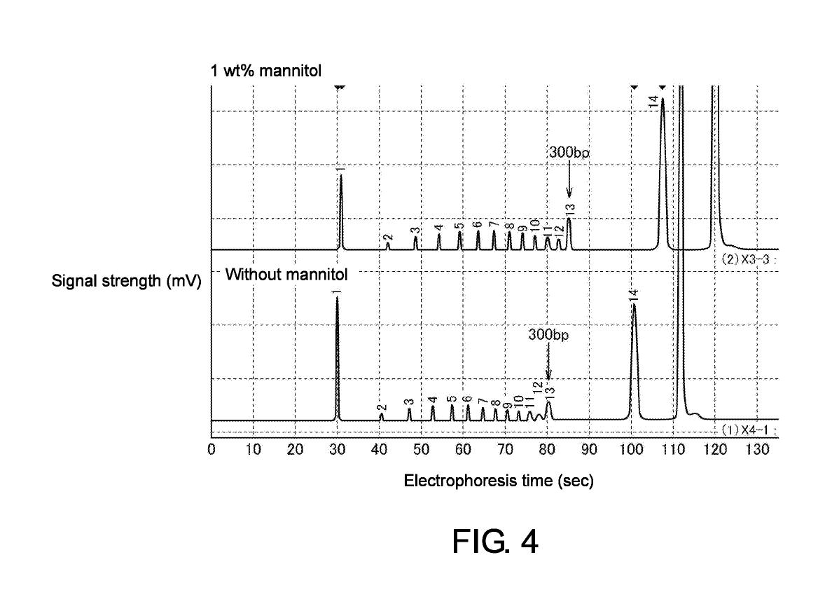

An experimental result is shown in FIG. 4 and Table 3, which is obtained by comparing the separation medium for electrophoresis of the embodiment (2.0% (w/v) HPMC (#2 in Table 1)+1 wt % mannitol; practical example 2), and the separation medium for electrophoresis which is without mannitol (2.0% (w/v) HPMC (#2 in Table 1); comparison example 2). The object substance is the 25 bp step ladder (to 300 bp) made by Promega Corporation, and the internal standard marker is the marker on a high molecular side included in the DNA-500 reagent kit for MCE (registered trademark)-202 MultiNA (registered trademark). By adding 1 wt % mannitol, the electrophoresis time is delayed, and the interval between the peaks near 300 bp is expanded and the separation performance is improved.

TABLE 3

| | | | Practical | Comparison |
|---|---|---|---|---|
| | | | example 2 | example 2 |
| Separation medium for electrophoresis | | | 2.0% (w/v) | 2.0% (w/v) |
| | | | HPMC (#2) + | HPMC (#2) |
| | | | 1 wt % mannitol | |
| Viscosity of separation medium for | | | 98 cP | 98 cP |
| electrophoresis | | | | |
| Electrophoresis time | #5 (100 | bp) | 59.26 | 57.40 |
| (sec) | #9 (200 | bp) | 74.20 | 70.60 |
| | #13 (300 | bp) | 85.28 | 80.42 |
| Degree of separation | 100 | bp | 5.97 | 4.71 |
| Rₛ | | | | |
| Size resolution (%) | 200 | bp | 2.81% | 3.79% |
| Δbp/bp | | | | |
| Separable size | 75 | bp | 2.7 bp | 3.2 bp |
| difference | | | | |
| Δbp | | | | |

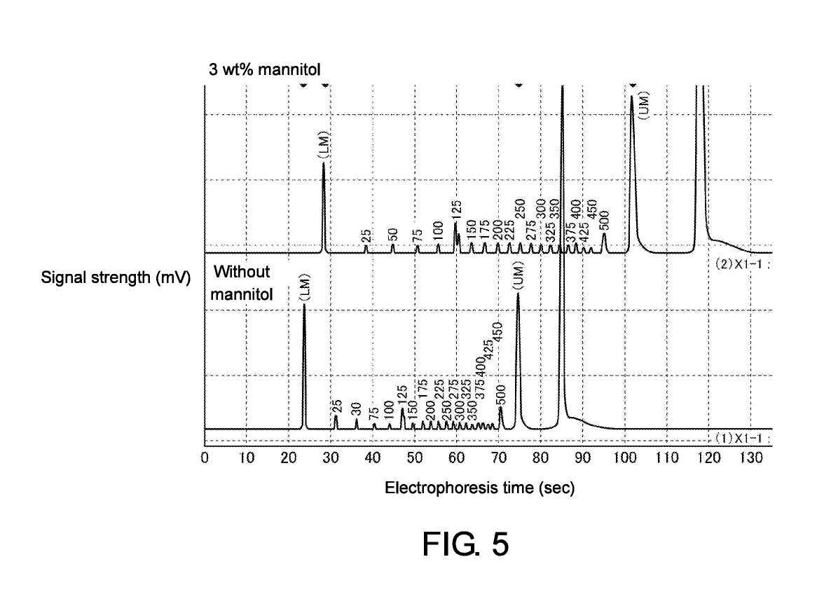

Next, an experimental result is shown in FIG. 5 and Table 4, which is obtained by comparing the separation medium for electrophoresis of the embodiment (2.0% (w/v) HPMC (#2 in Table 1)+3 wt % mannitol; practical example 3), and the separation medium for electrophoresis which is without mannitol (2.0% (w/v) HPMC (#2 in Table 1); comparison example 3). The object substance is the 25 bp step ladder (to 500 bp) made by Invitrogen Corporation, and the internal standard marker is the marker on a high molecular side included in the DNA-500 reagent kit for MCE (registered trademark)-202 MultiNA (registered trademark). By adding 3 wt % mannitol, the electrophoresis time is delayed, and the interval between the peaks near 300 bp is expanded and the separation performance is improved. Particularly the peak near 125 bp is separated into two peaks and the separation performance is improved greatly.

TABLE 4

| | | Practical | Comparison |
|---|---|---|---|
| | | example 3 | example 3 |
| Separation medium for electrophoresis | | 2.0% (w/v) | 2.0% (w/v) |
| | | HPMC (#2) + | HPMC (#2) |
| | | 3 wt % mannitol | |
| Viscosity of separation medium for | | 99 cP | 98 cP |
| electrophoresis | | | |
| Electrophoresis time | 100 bp | 55.74 | 44.12 |
| (sec) | 300 bp | 80.14 | 60.90 |
| | 500 bp | 95.10 | 70.64 |
| Degree of separation | 100 bp | 5.21 | 3.21 |
| Rₛ | | | |
| Size resolution (%) | 200 bp | 3.07% | 4.02% |
| Δbp/bp | | | |
| Separable size | 100 bp | 2.99 bp | 4.18 bp |
| difference | | | |
| Δbp | | | |

(Verification of Improvement Effect in Separation Performance by Adding Pullulan into HPMC)

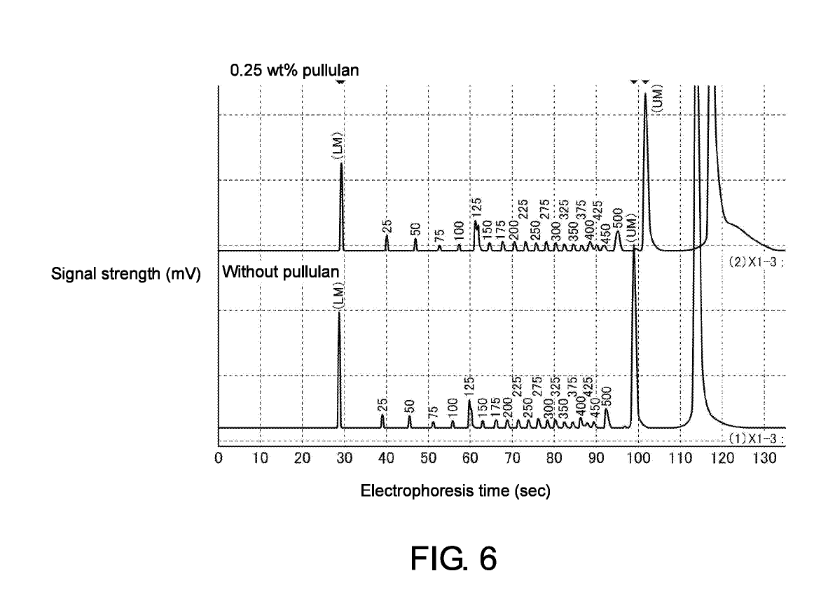

An experimental result is shown in FIG. 6 and Table 5, which is obtained by comparing the separation medium for electrophoresis of the embodiment (2.0% (w/v) HPMC (#2 in Table 1)+0.25 wt % pullulan; practical example 4), and the separation medium for electrophoresis which is without pullulan (2.0% (w/v) HPMC (#2 in Table 1); comparison example 4). The weight-average molecular weight of the pullulan used is 22800. The object substance is the 25 bp step ladder (to 500 bp) made by Invitrogen Corporation. The internal standard marker is the marker on a high molecular side included in the DNA-500 reagent kit for MCE (registered trademark)-202 MultiNA (registered trademark). By adding 0.25 wt % pullulan, an effect is confirmed that the electrophoresis time is delayed without expanding the peak width; for example, the degree of separation (Rₛ) at 200 bp is improved from 2.37 to 2.55.

TABLE 5

| | | Practical | Comparison |
|---|---|---|---|
| | | example 4 | example 4 |
| Separation medium for | | 2.0% (w/v) | 2.0% (w/v) |
| electrophoresis | | HPMC (#2) + | HPMC (#2) |
| | | 0.25 wt % pullulan | |
| Viscosity of separation medium for | | 108 cP | 98 cP |
| electrophoresis | | | |
| Electrophoresis time | 100 bp | 57.24 | 55.46 |
| (sec) | 300 bp | 80.14 | 78.02 |
| | 500 bp | 94.70 | 92.18 |
| Degree of separation | 200 bp | 2.55 | 2.37 |
| Rₛ | | | |
| Size resolution (%) | 200 bp | 4.02% | 4.02% |
| Δbp/bp | | | |
| Separable size | 75 bp | 3.16 bp | 4.18 bp |
| difference | | | |
| Δbp | | | |

(Experimental Data when HPMC with Different Weight-Average Molecular Weight is Used)

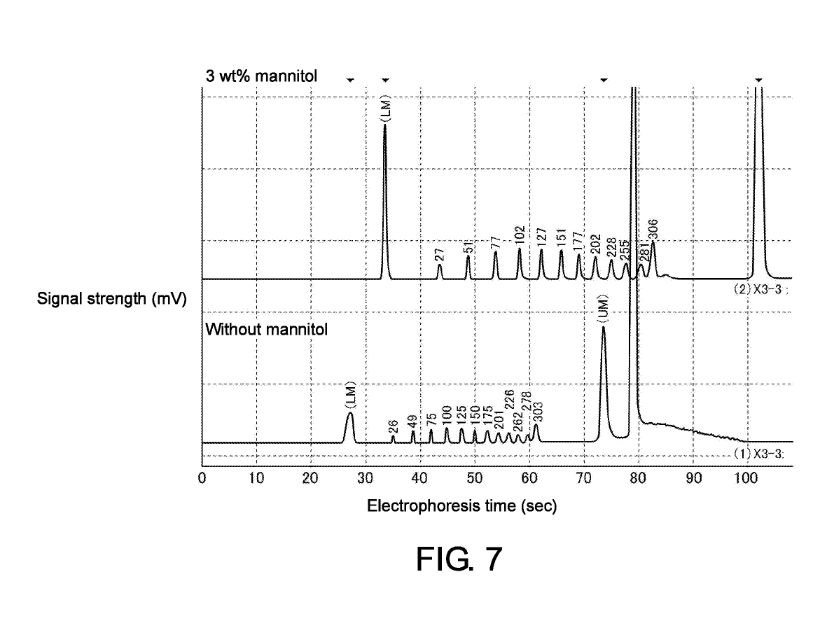

An experimental result is shown in FIG. 7 and Table 6, which is obtained by comparing the separation medium for electrophoresis of the embodiment (1.6% (w/v) HPMC (#1 in Table 1)+3 wt % mannitol; practical example 5), and the separation medium for electrophoresis which is without mannitol (1.6% (w/v) HPMC (#1 in Table 1); comparison example 5). The object substance is the 25 bp step ladder (to 300 bp) made by Promega Corporation. The internal standard marker is the marker on a high molecular side included in the DNA-500 reagent kit for MCE (registered trademark)-202 MultiNA (registered trademark). Even if HPMC having a small weight-average molecular weight is used, by adding 3 wt % mannitol, the electrophoresis time is delayed, and the interval between the peaks near 300 bp is expanded and the separation performance is improved on the whole (100 bp: Rₛ=3.61→4.71, 200 bp: Rₛ=1.84→2.29, 300 bp: Rₛ=1.23→1.50).

TABLE 6

| | | Practical | Comparison |
|---|---|---|---|
| | | example 5 | example 5 |
| Separation medium for electrophoresis | | 1.6% (w/v) | 1.6% (w/v) |
| | | HPMC (#1) + | HPMC (#1) |
| | | 3 wt % mannitol | |
| Viscosity of separation medium for | | 50 cP | 48 cP |
| electrophoresis | | | |
| Electrophoresis time | 100 bp | 58.14 | 44.88 |
| (sec) | 200 bp | 72.18 | 54.30 |
| | 300 bp | 82.62 | 61.14 |
| Degree of separation | 100 bp | 4.71 | 3.61 |
| Rₛ | 200 bp | 2.29 | 1.84 |
| | 300 bp | 1.50 | 1.23 |
| Size resolution (%) | 200 bp | 4.37% | 5.42% |
| Δbp/bp | | | |
| Separable size difference | 75 bp | 3.73 bp | 4.53 bp |
| Δbp | | | |

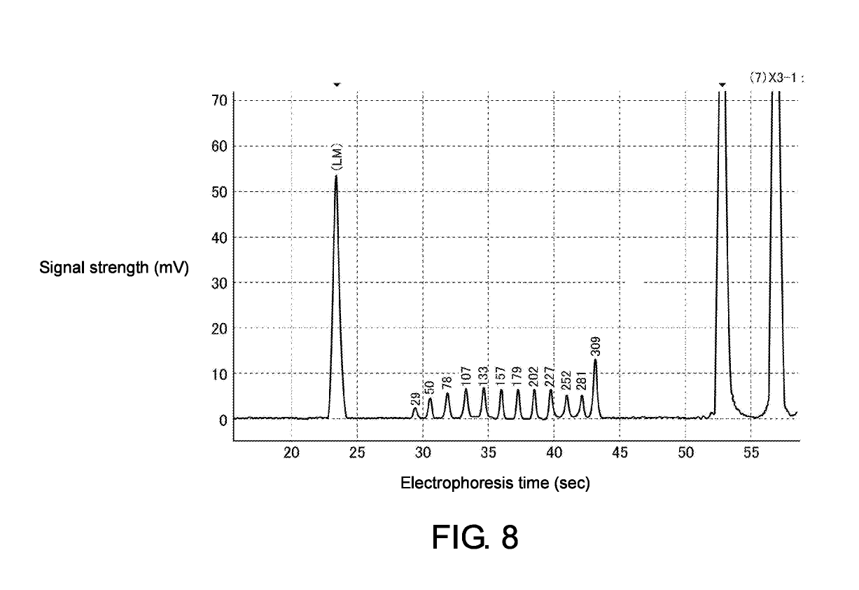

Next, an experimental result of 0.50% (w/v) HPMC (#3 in Table 1) solution (comparison example 6) serving as the separation medium for electrophoresis is shown in FIG. 8 and Table 7. The object substance is the 25 bp step ladder (to 300 bp) made by Promega Corporation. The internal standard marker is the marker on a high molecular side included in the DNA-500 reagent kit for MCE (registered trademark)-202 MultiNA (registered trademark). By diluting and using a high-molecular-weight HPMC, a separation with a short electrophoresis time is obtained, but even in this case, the delay effect of the electrophoresis time and the improvement in separation performance are suggested by adding mannitol.

TABLE 7

| | | Comparison example 6 |
|---|---|---|
| Separation medium for electrophoresis | | 0.5% (w/v) HPMC (#3) |
| Viscosity of separation medium for | | 140 cP |
| electrophoresis | | |
| Electrophoresis time (sec) | 100 bp | 33.22 |
| | 200 bp | 38.50 |
| | 300 bp | 43.10 |
| Degree of separation | 100 bp | 2.63 |
| Rₛ | | |
| Size resolution (%) | 200 bp | 3.88% |
| Δbp/bp | | |
| Separable size difference | 75 bp | 8.09 bp |
| Δbp | | |

According to the disclosure, a separation medium for electrophoresis having an improved separation performance without increasing a viscosity can be provided.

The embodiments and practical examples of the disclosure are described as above, but it has been intended from the beginning that structures of the embodiments and practical examples are appropriately combined.

It should be considered that the embodiments and practical examples disclosed here are illustrations instead of limitations. The scope of the disclosure is shown by the scope of patent claims instead of the above embodiments and practical examples, and intends to include the same meaning as the scope of patent claims and all modifications within the scope.

What is claimed is:

1. A separation medium for electrophoresis comprising:
a water-soluble cellulose derivative; and
a sugar alcohol derived from monosaccharide or disaccharide, or a low-molecular-weight polysaccharide.

2. The separation medium for electrophoresis according to claim 1, wherein the sugar alcohol comprises mannitol, erythritol, xylitol, lactitol, maltitol and sorbitol, or a combination thereof.

3. The separation medium for electrophoresis according to claim 1, wherein a weight-average molecular weight of the polysaccharide is 10000-80000.

4. The separation medium for electrophoresis according to claim 1, wherein the polysaccharide comprises pullulan, agarose, dextran, dextrin, amylose, xanthan gum, mannan, galactomannan, gellan gum, carrageenan, curdlan, pectine, welan gum, alginic acid, alginic acid salt, alginic acid ester, karaya gum, tamarind seed gum, rhamsan gum, or a combination thereof.

5. The separation medium for electrophoresis according to claim 1, wherein the sugar alcohol or the polysaccharide comprises mannitol, pullulan, or a combination thereof.

6. The separation medium for electrophoresis according to claim 1, wherein the water-soluble cellulose derivative comprises a repeating unit of cellulose, in which at least one hydrogen atom of a hydroxyl group is substituted by a substituent which is selected from a group consisting of an alkyl group having 1 to 3 carbon atoms, a hydroxyalkyl group having 1 to 3 carbon atoms, a carboxymethyl group having 2 to 4 carbon atoms, a group denoted by —(CH₂O)ₓ—H, a group denoted by —(CH₂CH₂O)_{y}—H, and a group denoted by —[CH₂CH(CH₃)O]_{z}—H (x, y, z respectively and independently represent a positive integer).

7. The separation medium for electrophoresis according to claim 1, wherein the water-soluble cellulose derivative comprises one or more than two selected from a group consisting of hydroxypropyl methylcellulose, methyl cellulose, hydroxymethyl cellulose, hydroxyethyl cellulose, hydroxypropyl cellulose, and carboxymethyl cellulose.

8. A reagent kit for electrophoresis comprising the separation medium for electrophoresis according to claim 1.

9. An electrophoresis method which is the electrophoresis method of an object substance in a sample, comprising:
(A) a process for introducing the sample to a flow path filled with the separation medium for electrophoresis according to claim 1; and
(B) a process for applying a voltage to the flow path to conduct an electrophoresis and separate the object substance in the sample.

10. The electrophoresis method according to claim 9, wherein the object substance comprises nucleic acid or protein.
